(19) United States
(12) Patent Application Publication
(10) Pub. No.: US 2003/0157245 A1
(43) Pub. Date: Aug. 21, 2003

(54) Method for forming a mirror coating onto an optical article

(76) Inventors: Sheila May Tatman, Seminole, FL (US); Hoa Thien Dang, Tampa, FL (US); Mark Mildebrath, Chico, CA (US); Sidney Shaw White JR., Seminole, FL (US)

Correspondence Address: Mark B Wilson, Fulbright & Jaworski, Suite 2400, 600 Congress Avenue, Austin, TX, 78701, US

(21) Appl. No.: 10/332,909

(22) PCT Filed: Jul. 13, 2001
(86) PCT No.: PCT/EP01/08172

(51) Int. Cl. B05D 5/06; B05D 3/12; B05D 3/02

(52) U.S. Cl. 427/162; 427/240; 427/387

(57) ABSTRACT

A method of forming a reflective coating onto a surface of a transparent substrate, the method comprising: spin coating the surface of the transparent substrate with at least one curable reflectance-imparting composition, and curing the at least one curable reflectance-imparting composition, thereby imparting a reflective property to the transparent substrate.

### BACKGROUND OF THE INVENTION

The present invention relates to a method for forming a reflective or mirror coating onto a surface of an optical article such as an ophthalmic lens and to the optical article resulting therefrom.

Mirror coated lenses, in particular, sunglass lenses, are widely used in the industry. Mirror coatings are useful for filtering light as well as creating a fashionable appearance.

Mirror coatings known in the art are multilayer structures that achieve their optical properties by means of thin film interference effects. Their multilayer structures are generally comprised of a plurality of dielectric and metallic layers, wherein the thickness and/or number of the respective layers are selected to provide a desired reflectance.

Typically, the reflective layers are mineral layers formed by vacuum deposition.

### DESCRIPTION OF THE PRIOR ART

Mirror coatings made of mineral multilayer structures formed by vacuum deposition are known in the art and disclosed, for example, in U.S. Pat. No. 5,928,718.

Vacuum deposition necessitates special equipment which are relatively sophisticated and costly.

Additionally, the use of the vacuum deposition technique may have some negative impact when the mirror coating is formed on a tinted organic glass.

Due to the high vacuum required for the deposition, the dye dispersed in the glass may migrate towards the organic glass surface.

There is thus a need for a process for making a reflective or mirror coating which would allow the use of a wider range of material including organic materials.

### SUMMARY OF THE INVENTION

It is a primary object of the present invention to provide a method for forming a reflective or mirror coating onto a surface of a transparent substrate such as an optical lens which avoids the use of vacuum deposition technique.

Another object of the present invention is to provide a method for forming a reflective or mirror coating onto a surface of a transparent substrate such as an optical lens which allows using curable organic reflectance-imparting compositions.

A further object of the present invention is to provide a method for forming a reflective or mirror coating onto a surface of a tinted optical transparent substrate which avoids possible migration of the dye within the transparent substrate.

More specifically, in accordance with the present invention, there is provided a method for forming a reflective or mirror coating onto a surface of a transparent substrate, the method comprising:

spin coating a surface of the transparent substrate with at least one curable reflectance-imparting composition, and

curing the at least one reflectance-imparting composition, thereby imparting a reflective property to the substrate.

### BRIEF DESCRIPTION OF THE DRAWINGS

The present invention may be more readily described with reference to the accompanying drawings in which:

FIGS. 1 to 3 are theoretical graphs of L*, a* and b* curves for standard quarter wave designs comprising multilayer stacks of high refractive index reflective layer (H) and lower refractive index reflective layer (L) wherein in FIG. 1 the stack is three layers HLH stack, in FIG. 2 the stack is a five layers HLHLH stack and in FIG. 3 the stack is a seven layers HLHLHLH stack; and

FIG. 4 is a theoretical graph of the reflectance (%) at a wavelength of 550 nm in function of the number of layers for standard quarter wave designs.

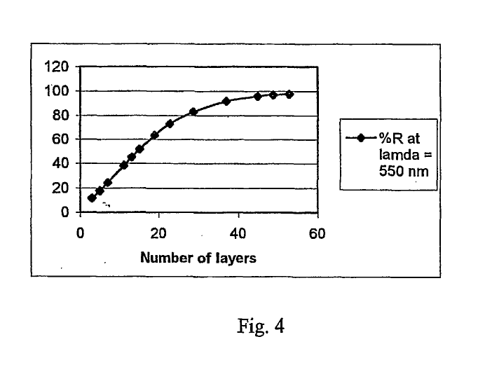

### DETAILED DESCRIPTION OF THE PREFERRED EMBODIMENTS

The method for forming a reflective or mirror coating onto a surface of an optical lens, preferably the convex face, comprises spin coating the surface with at least one curable reflectance-imparting composition and curing the at least one curable reflectance-imparting composition.

Preferably, the reflective or mirror coating is made of a multilayer stack comprised of alternate reflective layers of higher (n_{H}) and lower (n_{L}) refractive indexes, each of the layers of the stack being formed by successively spin coating an appropriate curable reflectance-imparting composition and curing it.

The curable reflectance-imparting compositions may be heat-cured (infrared or convection heating), UV-cured, or both heat and UV-cured depending upon the nature of the curable composition.

The thicknesses of the reflective layers in the coatings can vary, but preferably range from 20 nm to 600 nm and more preferably from 50 nm to 500 nm, with an optimal range from 100 to 300 nm, for imparting the desired properties.

Different methods may be used for designing the reflective stacks of layers.

The initial designs may be standard ¼ wave stacks that offer high reflectance at the design wavelength. In the simplest approach, there is applied a high index (n_{H}) layer followed by a low index layer followed by a high index (n_{H}) layer. By adding more layer pairs (high and low) the reflectance is increased.

By selecting different design wavelengths (=different layer thicknesses), different reflect colors can be obtained.

Using another method, to get certain colors, two designs or tune designs for certain reflectance shapes may have to be mixed. In fact, the desired reflectance color may be produced by finding some object with the desired reflect color and quality, measuring it using a spectrophotometer, and reverse engineering an optical stack to reproduce the same reflectance characteristic.

In summary, the stack design of the present invention can be realized by one of several methods.

Method 1—The stack may be realized by using a standard ¼ wave stack consisting of alternating layers of high and low index material layers.

Method 2—The stack may be realized by using designs utilizing layers of thickness other than ¼ wave thickness in order to achieve the desired optical effect.

Method 3—The stack may be realized by using non-standard designs obtained by reverse engineering. In this method a reflectance or transmission curve is obtained or synthesized. This curve represents the desired optical performance and may be obtained by measuring the reflectance or transmission of an item that exhibits the desired optical performance. This curve can then be used to reverse engineer a stack with the same or similar performance.

The optical characteristic can be obtained by using materials with several different qualities:

1) The materials can be optically clear in the visible region with indexes of refraction from between 1.3 to 3.0 and preferably between 1.4 and 2.0. As these materials are clear in the visible region the extinction coefficient k is small or very nearly equal to 0.

2) The materials can be optically colored in the visible region with indexes of refraction from between 1.3 and 3.0 and preferably between 1.4 and 2.0. As these materials are colored in the visible region the extinction coefficient, k is non-0 over at least a portion of the visible spectrum.

3) The materials can be metallic in nature exhibiting a high reflectance with various indexes of refraction and high extinction coefficients.

Equations that govern the designs:

n_{L}<n_{H}

n_{H} can have an index greater than, equal to, or less than the substrate

n_{L} can have an index greater than, equal to, or less than the substrate.

In the preferred designs n_{H}>n_{S} and n_{L}<n_{S}. (n_{S} is the refractive index of the substrate).

In the quarter wave design the thickness (d) for normal incidence is defined by the equation:

$$d = \frac{m λ}{4 n}$$

where λ is the design wavelength in nm, m is an odd integer and n is the index of refraction of the layer. In such cases the layers are referred to as quarter wave layers. The thickness d is given in nm. The reflectance curve can be determined using methods of calculation as found in texts such as:

1.) A. Thelen, “Design of Optical Interference Coatings”, McGraw Hill, New York, 1989.

2.) H. A. MacLeod, “Thin Film Optical Filters”, 2nd edition, McGraw Hill, New York, 1989.

3.) H. K. Pulker, “Coatings on Glass”, Elsevier, Amsterdam, 1984.

In the preferred method, m is 1 and λ varies between 400 nm and 700 nm.

Care must be taken to include absorption in the film if appropriate.

In non-quarter wave designs and normal incidence, m may have any value including non-integer values.

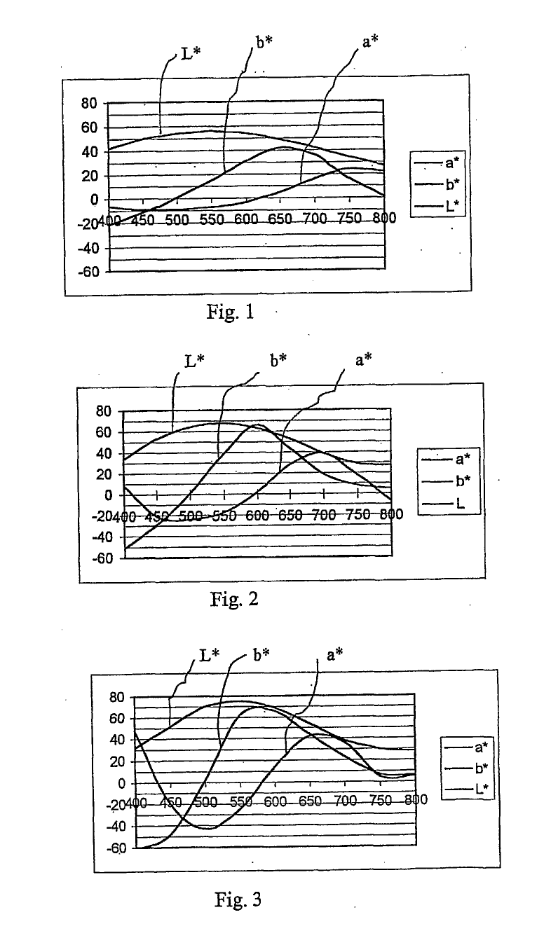

Curves as shown in FIGS. 1 to 3 can be used to select the desired reflect color. L*, a* and b* are defined hereinafter.

The reflective coatings obtained according to the method of the invention preferably have a mean reflectance ρₘ as defined in ISO/DIS 8980-4 (1998) of at least 4%, preferably at least 10%.

The curable reflectance-imparting compositions for use in the process of the invention may be any liquid reflectance-imparting composition that can be cured in a solid layer.

The compositions typically comprise a mineral charge, preferably metal oxide particles, dispersed in a liquid curable medium.

Such compositions are disclosed, for example, in U.S. Pat. No. 4,590,117.

Preferred liquid curable medium comprises at least one compound selected from the group consisting of an organic silicon compound represented by the following general formula:

Rₐ¹R_{b}²Si(OR)_{4-a-b}

wherein R¹ and R² independently stand for a hydrocarbon group having 1 to 10 carbon atoms, which contains an alkyl, alkenyl, aryl, halogeno, epoxy, amino, mercapto, methacryloxy or cyano group, R stands for an alkyl, alkoxy-alkyl or acyl group having 1 to 8 carbon atoms, a and b are 0 or 1, and the sum of a and b is 1 or 2, and an hydrolyzed product of said organic silicon compound.

As examples of the above-mentioned organic silicon compound, there can be mentioned trialkoxy-, triacyloxy- and triphenoxy-silanes such as methyltrimethoxysilane, methyltriethoxysilane, ethyltrimethoxy-ethoxysilane, methyltriacetoxysilane, methyltributoxysilane, ethyltrim-ethoxysilane, ethyltriethoxysilane, vinyltrimethoxysilane, vinyltri-ethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-methacryloxypropyltrimethoxysilane, γ-aminopropyltrimethoxysilane, γ-aminopropyltriethoxysilane, γ-mercaptopropyltrimethoxysilane, γ-mercaptopropyltriethoxysilane, N-β(aminoethyl)-γ-aminopropyl-trimethoxysilane, β-cyanoethyltriethoxysilane, methyltriphenoxysilane, chloromethyltrimethoxysilane, chloromethyltriethoxysilane, glycidoxy-methyltrimethoxysilane, glycidoxymethyltriethoxysilane, α-glycidoxyethyl-trimethoxysilane, α-glycidoxyethyltriethoxysilane, β-glycidoxyethyl-trimethoxysilane, β-glycidoxyethyltriethoxysilane, α-glycidoxypropyl-trimethoxysilane, α-glycidoxypropyltriethoxysilane, β-glycidoxypropyl-trimethoxysilane, β-glycidoxypropyltriethoxysilane, γ-glycidoxypropyltrim-ethoxysilane, γ-glycidoxypropyl-triethoxysilane, γ-glycidoxypropyl-tripropoxysilane, γ-glycidoxypropyltributoxysilane, γ-glycidoxypropyl-trimethoxyethoxysilane, γ-glycidoxypropyltriphenoxysilane, α-glycidoxy-butyltriethoxysilane, α-glycidoxybutyltriethoxysilane, β-glycidoxybutyl-trimethoxysilane, β-glycidoxybutyltriethoxysilane, γ-glycidoxybutyl-trimethoxysilane, γ-glycidoxybutyltriethoxysilane, δ-glycidoxybutyl-trimethoxysilane, δ-glycidoxybutyltriethoxysilane, (3,4-epoxycyclohexyl)-methyltrimethoxysilane, (3,4-epoxycyclohexyl)methyltriethoxysilane, β-(3,4-epoxycyclohexyl)ethyltrimethoxysilane, β-(3,4-epoxycyclo-hexyl)ethyltriethoxysilane, β-(3,4-epoxycyclohexyl)ethyltripropoxysilane, β-(3,4-epoxycyclohexyl)ethyltributoxysilane, β-(3,4-epoxycyclo-hexyl)ethyltrimethoxyethoxysilane, β-(3,4-epoxycyclohexyl)ethyl-triphenoxysilane, γ-(3,4-epoxycyclohexyl)propyltrimethoxysilane, γ-(3,4-epoxycyclohexyl) propyltriethoxysilane, δ-(3,4-epoxycyclohexyl)butyl-trimethoxysilane and δ-(3,4-epoxycyclohexyl)butyltriethoxysilane; and dialkoxysilanes and diacyloxysilanes such as dimethyldimethoxysilane, phenylmethyldimethoxysilane, dimethyidiethoxysilane, phenylmethyidi-ethoxysilane, γ-chloropropylmethyldimethoxysilane, γ-chloropropylmethyl-diethoxysilane, dimethyldiacetoxysilane, γ-methacryloxypropylmethyl-dimethoxysilane, γ-methacryloxypropylmethyldiethoxysilane, γ-mercapto-propylmethyidimethoxysilane, γ-mercaptopropylmethyldiethoxysilane, γ-aminopropylmethyldimethoxysilane, γ-aminopropylmethyidiethoxysilane, methylvinyidimethoxysilane, methylvinyidiethoxysilane, glycidoxymethyl-methyidimethoxysilane, glycidoxymethylmethyidiethoxysilane, α-glycidoxyethylmethyidimethoxysilane, α-glycidoxyethylmethyidiethoxysilane, β-glycidoxyethylmethyldimethoxysilane, β-glycidoxyethylmethyl-diethoxysilane, β-glycidoxypropylmethyldimethoxysilane, α-glycidoxy-propylmethyidiethoxysilane, β-glycidoxypropylmethyldimethoxysilane, β-glycidoxypropylmethyidiethoxysilane, γ-glycidoxypropylmethyidimethoxysilane, γ-glycidoxypropylmethyldiethoxysilane, γ-glycidoxypropyl-methyidipropoxysilane, γ-glycidoxypropylmethyidibutoxysilane, γ-glycidoxypropylmethyldimethoxyethoxysilane, γ-glycidoxypropylmethyl-diphenoxysilane, γ-glycidoxypropylethyidimethoxysilane, γ-glycido-xypropylethyidiethoxysilane, γ-glycidoxypropylvinyidimethoxysilane, γ-glycidoxypropylvinyldiethoxysilane, γ-glycidoxypropylphenyl-dimethoxysilane and γ-glycidoxypropylphenyidiethoxysilane.

These organic silicon compounds may be used either alone or in the form of a mixture of two or more of them. In order to impart the dye ability, use of epoxy group-containing organic silicon compounds is especially preferred.

These organic silicon compounds are preferably used after they are hydrolyzed.

The hydrolysis can be accomplished by adding pure water or an aqueous acid solution such as hydrochloric acid, acetic acid or sulfuric acid to the organic silicon compound and stirring the mixture. The degree of hydrolysis can easily be controlled by adjusting the amount of pure water or the aqueous acid solution used. In view of promotion of the hydrolysis, it is especially preferred that 1 to 3 moles, per mole of the alkoxy group, of pure water or the aqueous acid solution be added for the hydrolysis.

Since an alcohol or the like is produced upon hydrolysis, the hydrolysis can be carried out in the absence of a solvent. However, in order to perform the hydrolysis uniformly, there may be adopted a method in which the organic silicon compound is mixed with a solvent and the hydrolysis is then carried out. Furthermore, for a certain purpose, the hydrolyzed product may be used after an appropriate amount of the alcohol or the like produced by the hydrolysis is removed by heating and/or under reduced pressure.

The preferred trialkoxysilanes are methyltrimethoxysilane and glycidoxypropyltrimethoxysilane.

The mineral charge may be a metal, a metal oxide, a metal nitride, a metal fluoride or a mixture thereof. Preferably, the mineral charge is a metal oxide.

Such mineral charges are disclosed in U.S. Pat. No. 4,590,117.

As examples of useful charges and fillers, TiO₂ fillers and cerium oxide fillers can be cited, in particular HIT 32 M® which is a composite oxide of TiO₂/SnO₂/ZrO₂ in methanol with about 30% solid content.

Preferably, in the high index layer of the reflective coating, there is at most 80% by weight of solid filler based on the total weight of solid filler and solid material issued from the organic silicon compounds present in the high index layer coating composition.

The expression “weight of solid material issued from the organic silicon compounds” means the calculated weight of units:

$${R}_{a}^{1} {R}_{b}^{2} {SiO}_{\frac{( 4 - a - b )}{2}} .$$

wherein R¹, R², a and b have the same meaning as above and R¹ and R² are directly bonded to the silicon atom by a Si—C bond.

Various additives, for example, a leveling agent and a defoamer for improving the adaptability to the coating operation, an ultraviolet absorber and an antioxidant as the coating modifier, and a surfactant for giving an antifogging property and an antistatic property may be added to the liquid coating compositions.

In the coating operation, the compositions are ordinarily coated in the state diluted with a volatile solvent. The kind of the solvent is not particularly critical, but an appropriate solvent should be selected while the stability of the compositions, the wetting property to the transparent substrate and the volatility are taken into consideration. The solvent may be used either alone or as a mixture of two or more solvents.

By the term “liquid coating composition” used herein is meant a composition having a viscosity ordinarily applicable to the coating operation. The liquid coating composition has a viscosity preferably of not more than 10 poises, preferably not more than 1 poise, at the application temperature. In case of a liquid composition having too high a viscosity, it is difficult to obtain a uniform coating.

In order to attain the objects of the present invention, any transparent materials may be used as the transparent substrate, but in view of the fact that liquid compositions are coated, glass and plastic materials are especially preferred. As the plastic material, there are preferably used polymethyl methacrylate, a copolymer thereof, a polycarbonate, a diethylene glycol bisallyl carbonate polymer (CR-39®), a polyester, particularly polyethylene terephthalate, an unsaturated polyester, an acrylonitrile-styrene copolymer, a vinyl chloride polymer resin, a polyurethane and an epoxy resin. Glass substrates may also advantageously be used. Moreover, a substrate of a plastic material as mentioned above or a glass substrate, which is covered with a coating material, can also preferably be used.

The spin coating process of the invention can utilize any suitable device such as the Photo Resist model #1-PM101D-R465 from Headway Research, Inc. of Dallas, Tex. The liquid reflectance-imparting composition may be applied manually with a pipette in the Photo Resist spin coater. The coating spin speeds preferably range from 150 rpm to 1000 rpm and most preferably from 500 to 900 rpm. The spinning time during the coating process preferably ranges from 2 to 10 seconds, and most preferably from 3 to 6 seconds. The lenses are then spun to remove excess coating and to dry the lens. Spin-off and drying is preferably performed at spin speeds ranging from 1000 to 7000 rpm, and most preferably from 2000 to 5000 rpm. The spinning time is preferably from 15 seconds to 60 seconds, and most preferably from 20 seconds to 45 seconds.

The coated lenses were cured using suitable equipment, either a convection oven, infrared source, or ultraviolet source, according to the chemistry of the coatings.

The invention has the following advantages:

it allows preparing mirror coated lenses in less than one hour;

every lens can have a specific mirror treatment contrary to the batch technique of the prior art, i.e. the method of the invention is more flexible than the prior art method;

the method of the invention uses a low cost equipment;

spin coated mirror lenses have an improved resistance to temperature above 50° C. compared to the coating methods of the prior art using inorganic vapor deposited layers;

spin coated mirror layers have better adhesion when dipped in boiling water;

spin coated mirror lenses have very good impact resistance;

it allows to adjust the tintable properties of the spin mirror coated lenses.

Depending on the composition of the mirror coatings, the mirror coated lens can be tintable or not tintable.

The following examples illustrate the invention. In the examples, when otherwise stated, all parts and percentages are by weight.

All the lenses of the examples are made of diethylene glycol bisallylcarbonate (CR39®) polymer.

The thicknesses of the mirror coatings are physical thicknesses measured by interferometry method.

### EXAMPLE 1

This example relates to forming a reflective coating comprising a stack of three reflective layers.

Reflectance-Imparting Composition 1

γ-glycidoxypropyltrimethoxysilane (hereafter noted as Glymo) 2.08 parts was mixed with 0.50 parts of 0.1N hydrochloric acid and mixed overnight. The next day, 11.93 parts of 2-hydroxy-4-methyl pentanone and 73.91 parts of ethyl alcohol were added to the glymo solution and mixed. Next, 11.17 parts of Nissan HIT32M were added and mixed. Then 0.33 parts of aluminum acetyl acetonate were added and allowed to mix well. Finally, 0.08 parts of a surface active agent were mixed into the solution. The coating was filtered prior to the coating application (Refractive Index RI=1.75)

Reflectance-Imparting composition 2

Methyltrimethoxysilane, 1.43 parts was added to 13.40 parts of methyl-alcohol. Nalco 1034A 11.40 parts was added to the mixture and stirred overnight. Tetraethoxysilane 1.43 parts was hydrolyzed with 0.51 parts 0.1N hydrochloric acid and stirred overnight in a separate container. The next day, the tetraethoxysilane was added to the methyltrimethoxysilane mixture. 2-hydroxy-4-methyl pentanone 30.94 parts and 40.20 parts of ethyl alcohol was stirred into the solution. Aluminum acetyl acetonate, 0.46 parts, was then added and mixed. Finally 0.32 parts of surface active agent was mixed into the coating liquid. The liquid was filtered prior to application. (RI-1.38).

Composition 1 was applied, in the manner previously described, to a surface of a clear lens substrate at a thickness of 98 nanometers on the convex surface and cured via convection oven to form reflective layer 1. Composition 2 was applied, in the manner previously described, onto the cured reflective layer 1, at a thickness of 120 nanometers and cured via convection oven to form reflective layer 2. Composition 1 was then applied onto the cured reflective layer 2, in the manner previously described, at a thickness of 98 nanometers and cured via convection oven to form reflective the top or final reflective layer 3. The final lens was subjected to reflectance and color measurements. See Table I for the measurement results.

### EXAMPLE 2

Composition 1, from Example 1, was applied, in the manner previously described, to a tinted (in BPI Black, to approx. 25% transmission) lens substrate at a thickness of 98 nanometers on the convex surface and cured via convection oven to form reflective layer 1. Composition 2, from Example 1, was applied, in the manner previously described, onto the cured reflective layer 1, at a thickness of 120 nanometers and cured via convection oven to form reflective layer 2. Composition 1, from Example 1, was then applied onto the cured reflective layer 2, in the manner previously described, at a thickness of 98 nanometers and cured via convection oven to form the top or final reflective layer 3. The final lens was subjected to reflectance and color measurements. See Table I for the measurement results.

### EXAMPLE 3

Composition 1, from Example 1, was applied, in the manner previously described, to a tinted (in BPI Black, to approx. 25% transmission) lens substrate at a thickness of 77 nanometers on the convex surface and-cured via convection oven to form reflective layer 1. Composition 2, from Example 1, was applied, in the manner previously described, onto the cured reflective layer 1, at a thickness of 96 nanometers and cured via convection oven to form reflective layer 2. Composition 1 was then applied onto the cured reflective layer 2, in the manner previously described, at a thickness of 77 nanometers and cured via convection oven to form the top or final reflective layer 3. The final lens was subjected to reflectance and color measurements. See Table I for the measurement results.

### EXAMPLE 4

Reflectance-Imparting Composition 3

Glymo, 20.3 parts, was hydrolyzed with 4.6 parts of 0.1 N HCl. Nalco 1034A, 28.85 parts was added to the hydrolyzate and mixed well. Next, 41.5 parts methyl alcohol was added to the mixture and stirred overnight. The next day, methyl ethyl ketone, 3.4 parts, 1.34 parts aluminum acetyl acetonate, and surface active agent were introduced to the mixture and stirred well. The final solution was then diluted to 6 percent solids and filtered prior to application. (RI=1.48).

Composition 1 was applied, in the manner previously described, to a clear lens substrate at a thickness of 98 nanometers on the convex surface and cured via convection oven to form reflective layer 1. Composition 3 was applied, in the manner previously described, onto the cured reflective layer 1, at a thickness of 120 nanometers and cured via convection oven to form reflective layer 2. Composition 1 was then applied onto the cured reflective layer 3, in the manner previously described, at a thickness of 98 nanometers and cured via convection oven to form the top or final reflective layer 3. The final lens was subjected to reflectance and color measurements. See Table I for the measurement results.

### EXAMPLE 5

Composition 1 was applied, in the manner previously described, to a clear lens substrate at a thickness of 98 nanometers on the convex surface and cured via convection oven to form reflective layer 1. Composition 3 was applied, in the manner previously described, onto the cured reflective layer 1, at a thickness of 120 nanometers and cured via convection oven to form reflective layer 2. Composition 1 was then applied onto the cured reflective layer 3, in the manner previously described, at a thickness of 98 nanometers and cured via convection oven to form reflective layer 3. Compositions 3 and 1, respectively, were applied again, making the total number of layers 5. The final lens was subjected to reflectance and color measurements. See Table I for the measurement results.

### EXAMPLE 6

Composition 1 was applied, in the manner previously described, to a clear lens substrate at a thickness of 98 nanometers on the convex surface and cured via convection oven to form reflective layer 1. Composition 3 was applied, in the manner previously described, onto the cured reflective layer 1, at a thickness of 120 nanometers and cured via convection oven to form reflective layer 2. Composition 1 was then applied onto the cured reflective layer 3 in the manner previously described, at a thickness of 98 nanometers and cured via convection oven to form reflective layer 3. Compositions 3 and 1, respectively, were applied twice each, again, making the total number of layers 7. The final lens was subjected to reflectance and color measurements. See Table I for the measurement results.

### EXAMPLE 7

Composition 1 was applied, in the manner previously described, to a clear lens substrate at a thickness of 98 nanometers on the convex surface and cured via convection oven to form reflective layer 1. Composition 3 was applied, in the manner previously described, onto the cured reflective layer 1, at a thickness of 120 nanometers and cured via convection oven to form reflective layer 2. Composition 1 was then applied onto the cured reflective layer 3, in the manner previously described, at a thickness of 98 nanometers and cured via convection oven to form reflective layer 3. Compositions 3 and 1, respectively, were applied three times each, again, making the total number of layers 9. The final lens was subjected to reflectance and color measurements. See Table I for the measurement results.

TABLE I

| | Reflective | | | | | | Median | Visual |
|---|---|---|---|---|---|---|---|---|
| Substrate | layers | % T | Hue, visual | L* | a* | b* | Reflect | Reflect |
| Clear | None | 92.6% | White | 23.8 | 0 | −0.6 | 4.12% | 4.10% |
| Tinted | None | 27.6% | White | 23.2 | 1.4 | −0.8 | 4.14% | 4.09% |
| Clear | Ex. 1 | 89.0% | Red/orange | 31.1 | 8.4 | −2.1 | 11.26% | 10.15% |
| Tinted | Ex. 2 | 24.5% | Red/orange | 31.4 | 9.5 | −2.6 | 10.51% | 8.32% |
| Tinted | Ex. 3 | 24.6% | Green | 22.6 | −2.2 | 2.0 | 10.84% | 10.25% |
| Clear | Ex. 4 | 89.1% | Red/purple | 33.1 | −4.8 | 3.1 | 10.81% | 7.94% |
| Clear | Ex. 5 | 89.0% | Red | 32.3 | 5.0 | −0.4 | 11.89% | 8.63% |
| Clear | Ex. 6 | 88.0% | Orange | 30.1 | 15.4 | −4.2 | 11.91% | 8.79% |
| Clear | Ex. 7 | 87.9% | Gold | 37.3 | −7.2 | 17.1 | 13.12% | 14.55% |

Median reflectance corresponds to ρₘ as described in ISO/DIS 8980-4(Oct. 1, 1998).

Visual reflectance corresponds to ρᵥ as described in ISO/DIS 8980-4(Oct. 1, 1998).

The reflected color is determined by measuring the spectral reflectance at near-normal incidence (angle of incidence=15°). This can be done on any spectrophotometer, either single or dual beam. Our system is a single beam model (SMR). From this measurement, the color properties are determined. L*, a* and b* are calculated by utilizing the method adopted by the CIE (Commission Internationale de L'Eclairage) in 1978. The color scale is the CIE 1976 L*, a*, b* or CIELAB. In our data, the 10° 1964 CIE standard observer is used along with the D65 Illuminant. L* is a measurement of the brightness of the object. a* measures the red to green color (+a* is red and −a* is green). b* measures the blue to yellow color (+b* is yellow and −b* is blue). The sign of the two values determines the color (hue) the magnitude of the numbers indicates the color saturation.

1. A method of forming a reflective coating onto a surface of a transparent substrate, the method comprising:
spin coating the surface of the transparent substrate with at least one curable reflectance-imparting composition, and
curing the at least one curable reflectance-imparting composition, thereby imparting a reflective property to the transparent substrate.

2. The method of claim 1, wherein the reflective coating is a multilayer stack comprised of alternate reflective layers of higher (n_{H}) and lower (n_{L}) refractive indexes, each of the layers of the stack being formed by successively spin coating an appropriate curable reflectance-imparting composition and curing it.

3. The method of claim 2, wherein the stack comprises at least 3 reflective layers, preferably at least 5 and more preferably 5 to 9.

4. The method of claim 2, wherein the higher refractive index (n_{H}) is higher than the refractive index (n_{S}) of the transparent substrate and the lower index (n_{L}) is lower than the refractive index (n_{S}) of the substrate.

5. The method of claim 2, wherein the higher index (n_{H}) and the lower index (n_{L}) range from 1.3 to 3.0.

6. The method of claim 2, wherein the higher index (n_{H}) and the lower index (n_{L}) range from 1.4 to 2.0.

7. The method of claim 2, wherein the reflective layers have a thickness ranging from 20 to 600 nm.

8. The method of claim 2, wherein the reflective layers have a thickness ranging from 50 to 500 nm.

9. The method of claim 2, wherein spin coating comprises a first coating step at a spinning speed ranging from 150 rpm to 1000 rpm followed by a drying step at a spinning speed ranging from 1000 rpm to 7000 rpm.

10. The method of claim 2, wherein the reflectance-imparting composition is a curable liquid composition comprising a mineral filler dispersed in a curable liquid medium.

11. The method of claim 10, wherein the curable liquid medium comprises at least one alkoxysilane or a hydrolysate thereof.

12. The method of claim 11, wherein the alkoxysilane is selected from tetraalkoxysilane and trialkoxysilane.

13. The method of claim 12, wherein the alkoxysilane is a alkyltrialkoxysilane, an epoxytrialkoxysilane or a mixture thereof.

14. The method of claim 13, wherein the alkyltrialkoxysilane is methyltrimethoxysilane and the epoxytrialkoxysilane is γ-glycidoxy-trimethoxysilane.

15. The method of claim 10, wherein the filler is selected from metal oxide particles and mixtures thereof.

16. The method of claim 2, wherein the curing of the layers comprises heat curing and/or UV curing or both depending upon the chemistry of the reflectance-imparting composition.

17. The method of claim 2, wherein the transparent substrate is a mineral or organic glass.

18. The method of claim 17, wherein the glass is a tinted glass.

19. The method of claim 2, wherein the transparent substrate is an ophthalmic lens.

20. The method of claim 19, wherein the ophthalmic lens is made of organic glass.

21. The method of claim 20, wherein the organic glass is tinted.

22. The method of claim 19, wherein the coated surface of the lens is the convex surface thereof.
